(19) United States
(12) Patent Application Publication
(10) Pub. No.: US 2020/0295622 A1
(43) Pub. Date: Sep. 17, 2020

(54) AXIAL FLUX ELECTROMAGNETIC MOTOR OR GENERATOR HAVING A COOLING CIRCUIT COMMON TO THE MOTOR AND TO ITS ELECTRONIC CONTROL AND POWER MEANS

(71) Applicant: Whylot SAS, CAMBES (FR)

(72) Inventors: Bruno CARSALADE, Figeac (FR); Romain RAVAUD, Labastide-Murat (FR); Vasile MIHAILA, Figeac (FR)

(73) Assignee: Whylot SAS, CAMBES (FR)

(21) Appl. No.: 16/753,686

(22) PCT Filed: Nov. 5, 2018
(86) PCT No.: PCT/IB2018/001222

§ 371 Date: Apr. 3, 2020

(30) Foreign Application Priority Data
Nov. 7, 2017 (FR) 1701155

(51) Int. Cl. H02K 5/20; H02K 9/19; H02K 11/33; H02K 16/04; B60K 1/00

(52) U.S. Cl. CPC H02K 5/20; H02K 9/19; H02K 2211/03; H02K 16/04; B60K 1/00; H02K 11/33

(57) ABSTRACT

The present invention relates to a motor (M) or axial flux electromagnetic generator with at least one rotor and at least one stator housed in a housing (1), the housing (1) having internally a cooling fluid circuit and surrounding the motor (M) while allowing only an end portion of the driveshaft of the rotor to protrude therefrom, the electromagnetic motor (M) or the generator having electronic control and power means (4). The cooling circuit has a common element that cools at least one rotor and one stator and also the electronic control and power means (4).

The present invention relates to an axial flux electromagnetic motor or generator having a cooling circuit common to the motor and to its electronic control and power means.

This invention can be applied advantageously but not restrictively for an axial flux electromagnetic motor that delivers high power at a high speed of rotation of the rotor, which is facilitated by the specific characteristics of the motor of generator according to the present invention. A motor of this type can be used, for example, as an electromagnetic motor in a fully electric or hybrid automotive vehicle.

Advantageously but not restrictively, the electromagnetic motor or generator can comprise at least one rotor framed by two stators, whereby these elements can be superimposed on each other and can be separated by at least one air gap on the same shaft.

In high-speed applications it is necessary to have a very good mechanical strength of the rotating part, i.e. the rotor, to improve the reliability of the system. It is also necessary to cool the components of the motor, in particular its rotor or rotors and its stator or stators.

It is known that a motor can be cooled by a cooling circuit that makes possible the circulation of a cooling fluid, frequently water-based, in the interior of the motor.

The motor or the generator is also associated with electronic control and power means that generate heat and must therefore be frequently cooled or ventilated. This requires the presence of ventilation or a specific cooling circuit for these electronic control of power means, which increases the size of the motor.

These electronic control and power means can also be placed at some distance from the motor and from the generator, which necessitates wiring and makes assembly more complex. When these electronic control and power means are located in proximity to the motor or to the generator, they experience heating due to the motor and require an even more efficient cooling system, which increases the price of the overall motor and the associated electronic control and power means.

US 2014232217A1, which is considered to be the closest prior art, describes a electromagnetic motor or generator although it is not an axial flux machine with at least one rotor and at least one stator located in a housing that has an internal cooling fluid circuit and surrounds the motor, allowing only an end portion of a drive shaft of the rotor to protrude therefrom. The electromagnetic motor or generator has electronic control and power means. The cooling circuit has a common element that provides cooling of, on one hand, the at least one rotor and one stator and, on the other hand, the electronic control and power means.

A cooling system of a radial flux motor as described in this document cannot be transposed to an axial flux motor without specific adaptation. These two types of motors have different technical characteristics and are subject to heating which is not the same and cannot be treated in a similar fashion. The basic problem addressed by the present invention is to design an axial flux electromagnetic motor or generator assembly with associated electronic control and power means that can guarantee protection against heating of the assembly caused in particular by one or more of the rotors rotating at very high speeds and losses caused by the Joule effect in the stator or stators while having a reduced size.

For this purpose, the present invention relates to an electromagnetic motor or generator with at least one rotor and at least one stator located in a housing, the housing having an internal cooling fluid circuit and surrounding the motor and allowing only a portion of the extremity of a drive axis of the rotor to protrude therefrom, the electromagnetic motor or generator having electronic control and power means, the cooling circuit having a common element ensuring the cooling, on one hand, of the at least one rotor and one stator, and, on the other hand, electronic control and power means, characterized in that the electromagnetic motor or generator is an axial flux machine and that the common element is in the shape of a cooling ring enclosing a fluid input ring containing the cooling circuit in its interior and having a section that includes at least one inlet and one outlet for the cooling fluid, the cooling ring forming a rear portion of the housing. The technical effect is to combine the cooling means of the motor of generator with the cooling means of the electronic control and power means, which represents an economy of means, a cost reduction and a saving of space for the assembly consisting of the motor and electronic means. The electronic control and power means are close to the motor and benefit from its cooling system via a cooling fluid circuit.

It is this ring with an input and output for the cooling fluid that forms the principal part of the cooling circuit with the circuit forming coils that are advantageously wound in a spiral fashion or concentrically in its interior.

Advantageously, a hood axially extends the housing while surrounding and protecting the electronic control and power means of the motor, the housing and the hood forming an enclosed assembly that contains in its interior the at least one rotor and one stator and the electronic control and power means. The hood is adjacent to the housing, fastened to the housing and contains the electronic control and power means. The assembly consisting of the motor or generator and the electronic control and power means is therefore more compact while providing effective protection for their associated components.

The hood is advantageously affixed by removable fastening means on the cooling ring that forms the rear portion of the housing.

The hood advantageously at least partly covers or is adjacent to the cooling ring in the installed position of the hood on the housing, the hood being traversed by peripheral borings distributed regularly around a circumference of the hood for the passage of the fastening means of the hood with a free extremity of one arm of a respective bracket, a free extremity of the other arm of each bracket having means for fastening with the cooling ring. The electronic control and power means are advantageously in the form of a printed circuit board.

The cooling ring of the cooling fluid circuit has one face facing the at least one rotor and one stator of the motor and one opposite face in contact against the electronic control and power means.

The printed circuit board is advantageously in the form of a disk in contact against the opposite face of the cooling plate, the printed circuit board having a surface that is similar to or less than 10% smaller than the cooling ring. Because the surface areas of the cooling plate and the printed circuit board are essentially equivalent, the cooling of the printed circuit board by the cooling plate is optimal.

A forward portion of the housing advantageously has a front ring, the front ring and the fluid input ring having the same diameter and surrounding between them a cylindrical portion with a diameter less than the diameter of the front ring and fluid input ring, the front ring and fluid input ring being fastened to each other and held at some distance from each other by threaded rods that extend lengthwise between the front and fluid input rings and are regularly spaced in proximity to the periphery of the front and fluid input rings, a portion of each longitudinal extremity of each threaded rod running through a respective ring.

The front ring, the cylindrical portion, the fluid input ring and the cooling ring define the exterior of the motor housing.

The front ring advantageously integrates a portion of an auxiliary cooling fluid circuit. This makes possible the cooling of both sides of the motor of generator. This auxiliary circuit can be independent from or connected to the cooling circuit common to the electronic means and to the motor or to the generator.

The front ring advantageously has a median recess for the passage of the rotor drive shaft.

The electromagnetic motor or generator comprises at least one rotor associated with two stators.

Other characteristics, objects and advantages of the present invention are explained in greater detail in the following description and with reference to the accompanying drawings, which are included by way of nonrestrictive examples and in which:

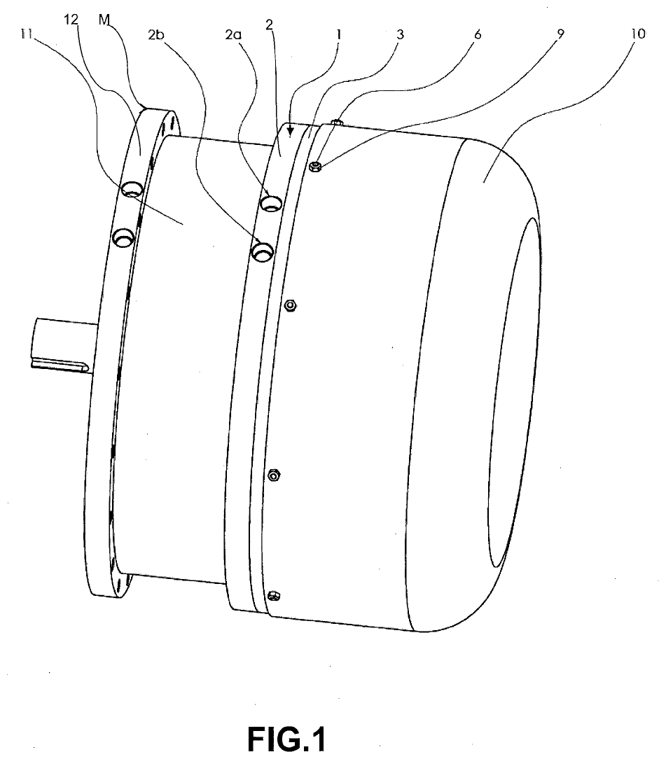

FIG. 1 is a schematic representation of a perspective view of a motor housing comprising a hood that houses electronic control and power means for an axial flux electromagnetic machine according to one embodiment of the present invention, a cooling circuit being integrated into the housing and common for the mechanical and electrical components of the motor and the electronic control and power means, and

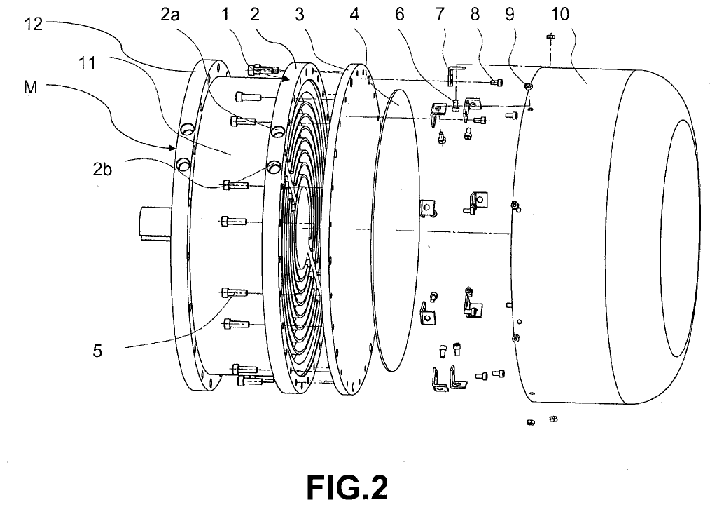

FIG. 2 is a schematic representation of an exploded view of an axial flux electromagnetic machine according to the embodiment of the present invention illustrated in FIG. 1.

The figures are given by way of example and are not restrictive of the invention. They constitute schematic representations designed to facilitate an understanding of the invention and do not necessarily illustrate practical applications drawn to scale. In particular, the dimensions of the different parts are not representative of reality.

For simplification, what is called the cooling circuit is the cooling circuit strictly speaking as well as its coating or wrapping, for example, a fluid input ring as the principal portion of the cooling circuit as well as a cooling plate.

With reference to FIGS. 1 and 2, the present invention relates to an axial flux electromagnetic motor M or an generator with at least one rotor and at least one stator housed in a housing 1.

The housing 1 has an internal cooling fluid circuit and surrounds the motor M, allowing only an end portion of a drive shaft of the rotor to protrude therefrom. The electromagnetic motor M or the generator also has electronic control and power means 4.

According to the invention, the cooling circuit has a common component 3 that provides cooling of, on one hand, the at least one rotor and one stator and, on the other hand, of the electronic control and power means 4.

The accompanying figures show an input 2a and an output 2b of the cooling fluid in the housing 1. The cooling circuit is internal to the housing 1. The common element 3 that provides the cooling of the at least one rotor and one stator and of the electronic control and power means 4 can be in the form of a cooling plate, advantageously a cooling disk.

A hood 10 can axially extend the housing 1 while surrounding and protecting the electronic control and power means 4 of the motor M. The housing 1 and the hood 10 then form a closed assembly containing in its interior the at least one rotor and one stator and the electronic control and power means 4 separated by the common cooling element 3.

The electronic control and power means 4 can be in the form of a printed circuit board 4, advantageously forming a disk.

As noted above, the cooling fluid circuit can comprise a cooling plate 3 forming the common cooling element. The cooling plate 3 can have one face facing the at least one rotor and one stator of the motor M and an opposite face in contact against the electronic control and power meets 4.

The cooling fluid circuit can comprise a principal portion 2, advantageously in the form of a ring called the fluid input, housing the coils, the fluid input ring 2 being closed by the cooling plate 3. The cooling plate 3 can be attached by threaded rods 5 with the principal portion 2, advantageously in the form of a fluid input ring.

Brackets 7 or L-shaped pieces with two arms perpendicular to each other can be attached on one extremity of an arm to the hood 10 and on the other extremity to the cooling plate 3 on the face facing the electronic control and power means 4 on the periphery of this face of the cooling plate 3.

The fastening can be accomplished by means of retaining screws or bolts identified as 8 when associated with the cooling plate 3 and identified as 6 when associated with the hood 10, in which case the bolts 6 can be associated with nuts 9 that are located on the exterior of the hood 10.

For simplification, a reference number 7 is assigned to a single bracket, a single bolt associated with the cooling plate 3 is identified as 8, and likewise a single bolt and a single nut associated with the hood 10 are identified respectively as 6 and 9, although what is indicated for a component referenced by a given number also applies for all the similar components represented in the accompanying figures.

The printed circuit board 4 can be in the form of a disk in face-to-face contact with the opposite face of the cooling plate 3, i.e. the face of the cooling plate 3 turned toward the inside of the hood 10. Although it is not restricted to this configuration, the printed circuit board 4 can have a surface area similar to or less than 10% smaller than the cooling plate 3 so that the cooling surface is large.

The cooling plate 3 can be in the form of a cooling ring and closing a fluid entry ring 2 as the principal portion of the cooling circuit. The fluid input ring 2 can contain the cooling circuit strictly speaking in its interior, with a section that contains at least one input 2a and one output 2b for the cooling fluid, which is advantageously a liquid, preferably a water-based liquid.

As indicated above for the cooling plate 3, the cooling ring 3 can form a rear part of the housing 1 on which the hood 10 is fixed by removable fastening means 6 to 9 in the form of brackets 7 with holding screws or bolts identified as 8 when associated with the cooling ring 3 and identified as 6 when associated with the hood 10, with in that case nuts 9.

The hood 10 can cover the cooling ring 3 in the assembled position of the hood 10 on the housing 1. The hood 10 can be pierced by peripheral borings regularly distributed around a circumference of the hood 10 for the passage of fastening means 6 of the hood 10 with one free extremity of one leg of a respective bracket 7.

One free end of the other leg of each bracket 7 can have fastening means 8 with the cooling ring 3, the fastening means being in the form of retaining screws or bolts.

A front portion of the housing 1 can have a front ring 12. In this case, the front ring 12 and the fluid input ring 2 can have the same diameter and between them surround a cylindrical portion 11 with a diameter less than the diameter of the front ring and fluid input ring 2.

The front ring 12 and fluid input ring 2 can be fastened to one another while being kept apart from each other by threaded rods that extend lengthwise between the front ring 12 and the fluid input ring 2 and arranged at regular intervals in proximity to the periphery of the front ring 12 and the fluid input ring 2.

A portion of each longitudinal extremity of each threaded rod can run through a respective front ring 12 and fluid input ring 2, these threaded rods not being shown in the figures.

The front ring 12 can incorporate a portion of an auxiliary cooling fluid circuit. This auxiliary circuit can be connected or not connected to the cooling fluid circuit toward the extremity of the housing 1 adjacent to the hood 10 passing through the fluid input ring 2.

The front ring 12 can have a median recess for the passage of the rotor drive shaft.

In one preferred but not restrictive embodiment of the invention, the electromagnetic motor and/or the generator can comprise at least one rotor associated with two stators.

The cooling fluid of the cooling circuit internal to the housing 1 can be cooled in a radiator located at some distance from the motor M or from the electromagnetic machine. For an electric or hybrid automotive vehicle, this radiator can be a high-temperature or low-temperature radiator located in the front facade of the automotive vehicle.

The radiator can be used to cool the cooling fluid of other elements of the electric propulsion system such as a heat exchanger associated with a traction battery or other electronic components exterior to the motor M such as an inverted rectifier. It can also be used for the cooling of a cooling fluid that runs through a thermal motor when such a motor is present.

1. An electromagnetic Motor (M) or generator with at least one rotor and at least one stator housed in a housing (1), the housing (1) having internally a cooling fluid circuit and surrounding the motor (M), leaving only an end portion of a rotor driveshaft protruding therefrom, the electromagnetic motor (M) or generator having electronic control and power means (4), the cooling circuit having a common element (3) that provides the cooling of, on one hand, the at least one rotor and one stator and, on the other hand, of the electronic control and power means (4), characterized in that the electromagnetic motor (M) or generator is an axial flux machine and that the common element (3) is in the form of a cooling ring that closes a fluid input ring (2) containing the cooling circuit in its interior and having a section that comprises at least one input (2a) and one output (2b) for the cooling fluid, the cooling ring (3) forming a rear part of the housing (1).

2. A motor (M) according to claim 1, in which a hood (10) axially extends the housing (1), surrounding and protecting the electronic control and power means (4) of the motor (M), the housing (1) and the hood (10) forming a closed assembly that contains in its interior the at least one rotor and one stator and the electronic control and power means (4).

3. A motor (M) according to claim 2, in which the hood (10) is fastened by removable fastening means (6 to 9) onto the cooling ring (3) forming the rear part of the housing (1). p\hat{ }p

4. A motor (M) according to claim 1, in which the hood (10) at least partly covers or is adjacent to the cooling ring (3) in the assembled position of the hood (10) on the housing (1), the hood (10) being traversed by peripheral borings regularly distributed around a circumference of the hood (10) for the passage of fastening means (6) of the hood (10) with one free end of one leg of a respective bracket (7), one free end of the other leg of each bracket (7) having means (8) for fastening with the cooling ring (3).

5. A motor (M) according to claim 1, in which the electronic control and power means (4) are in the form of a printed circuit board.

6. A motor (M) according to claim 1, in which the cooling ring (3) of the cooling fluid circuit has one face facing the at least one rotor and one stator of the motor (M) and an opposite face in contact against the electronic control and power means (4).

7. A motor (M) according to claim 1, in which the printed circuit board (4) is in the form of a disk in contact against the opposite face of the cooling ring (3), the printed circuit board (4) having a surface area similar to or less than 10% smaller than the cooling ring (3).

8. A motor (M) according to claim 1, in which a front part of the housing (1) has a front ring (12), the front ring (12) and the fluid input ring (2) having the same diameter and surrounding between them a cylindrical portion (11) with a diameter less than the diameter of the front ring (11) and fluid input ring (2), the front ring (11) and the fluid input ring (2) being fastened to each other and held at some distance from each other by threaded rods that extend lengthwise between the front ring (11) and fluid input ring (2) and are regularly spaced in proximity to the periphery of the front ring (11) and fluid input ring (2), a portion of each longitudinal end of each threaded rod running through a respective ring (12).

9. A motor according to claim 8 in which the front ring (12) incorporates a portion of an auxiliary cooling fluid circuit.

10. A motor (M) according to claim 8, in which the front ring (12) has a median recess for the passage of the rotor drive shaft.

11. A motor (M) according claim 1, which comprises at least one rotor associated with two stators.
